(19) United States
(12) Patent Application Publication
(10) Pub. No.: US 2025/0115711 A1
(43) Pub. Date: Apr. 10, 2025

(54) POLYETHER POLYMERIZATION PROCESS

(71) Applicant: Dow Global Technologies LLC, Midland, MI (US)

(72) Inventors: David K. Steelman, Angleton, TX (US); Nima Nikbin, Lake Jackson, TX (US); Arjun Raghuraman, Pearland, TX (US); Robin P. Ziebarth, Midland, MI (US); John W. Weston, Sugar Land, TX (US)

(21) Appl. No.: 18/695,916

(22) PCT Filed: Sep. 30, 2022
(86) PCT No.: PCT/US2022/045377

§ 371 Date: Mar. 27, 2024

Related U.S. Application Data
(60) Provisional application No. 63/271,653, filed on Oct. 25, 2021.

(51) Int. Cl. C08G 65/26; C08K 5/06

(52) U.S. Cl. CPC C08G 65/2663; C08G 65/2696; C08K 5/06; C08G 2650/22

(57) ABSTRACT

Alkylene oxides are polymerized in the presence of a catalyst system that includes a double metal cyanide catalyst. At least one additive is present. The additive is an alkali metal, ammonium or quaternary ammonium salt of a monocarboxylic acid having up to 24 carbon atoms; monobasic potassium phosphate, a monobasic ammonium or quaternary ammonium phosphate, a dibasic ammonium and quaternary ammonium phosphate or phosphoric acid.

This invention relates to processes for polymerizing alkylene oxides to form polyethers.

Poly(alkylene oxides) are produced globally in large quantities by polymerizing one or more alkylene oxides in the presence of a polymerization catalyst. They are important raw materials for producing polyurethanes and are used as surfactants and industrial solvents, among other uses. The predominant polymerization catalysts are alkali metal hydroxides or alkoxides and certain metal complexes that are commonly referred to as double metal cyanide (DMC) catalysts.

Double metal cyanide catalysts have certain advantages. They do not strongly catalyze a rearrangement of propylene oxide to form propenyl alcohol. Polyether polyols made using DMC catalysts therefore tend to have lower quantities of unwanted monofunctional polymers. In addition, DMC catalyst residues usually do not need to be removed from the product. Doing so avoids neutralization and catalyst removal steps that are needed when alkali metal catalysts are used.

DMC catalysts have certain disadvantages, however. They exhibit a latency period after being exposed to an alkylene oxide under polymerization conditions before they become “activated” and rapid polymerization begins. Another significant problem is that DMC catalysts perform sluggishly in the presence of high concentrations of hydroxyl groups. For this reason, DMC catalysts are disfavored when making low molecular weight products and in semi-batch processes that begin with low equivalent weight starters.

U.S. Pat. No. 9,040,657 discloses a method of producing a polyether monol or polyol in the presence of the DMC catalyst and a magnesium, Group 3-Group 15 metal or lanthanide series compound in which a magnesium, Group 3-Group 15 metal or lanthanide series metal is bonded to at least one alkoxide, aryloxy, carboxylate, acyl, pyrophosphate, phosphate, thiophosphate, dithiophosphate, phosphate ester, thiophosphate ester, amide, siloxide, hydride, carbamate or hydrocarbon anion, the magnesium, Group 3-Group 15 or lanthanide series metal compound being devoid of halide anions. This technology is very effective in reducing the activation time and in improving the catalyst performance when exposed to high concentrations of hydroxyl groups. Nonetheless, further improvements are desirable; in particular a catalyst system that performs better under stringent polymerization conditions and/or in polymerizing ethylene oxide would be beneficial.

This invention is a method for producing a polyether, the method comprising:
I. forming a reaction mixture comprising a) a hydroxyl-containing starter, b) at least one alkylene oxide, c) a water insoluble polymerization catalyst complex that includes at least one double metal cyanide compound and d) an additive selected from the group consisting of alkali metal, ammonium and quaternary ammonium salts of monocarboxylic acids having up to 24 carbon atoms; monobasic alkali metal phosphates, dibasic sodium phosphate, monobasic ammonium phosphate, monobasic quaternary ammonium phosphates, tartaric acid, malic acid and succinic acid, and
II. polymerizing the alkylene oxide onto the hydroxyl-containing starter in the presence of the water insoluble polymerization catalyst complex and the additive to produce the polyether.

The presence of the additive has been found to increase the activity of the double metal cyanide catalyst significantly, even when a “promoter” compound such as described in WO 2012/091968 is present. The additive enhances catalyst activation and polymerization rates under conditions of high hydroxyl concentrations and/or very low molecular weight starters. Very significantly, the presence of the additive improves catalyst performance in ethylene oxide polymerizations. With this invention, ethylene oxide can be polymerized onto even low molecular weight starters, and even under conditions of high hydroxyl concentrations, to produce poly(ethylene oxide) polymers of controlled molecular weight and low polydispersities.

In the process of the invention, a polymerization mixture that includes a) a hydroxyl-containing starter, b) at least one alkylene oxide, c) a water insoluble polymerization catalyst complex that includes at least one double metal cyanide compound and d) an additive as described herein. A polyether is produced by polymerizing the alkylene oxide onto the hydroxyl-containing starter in the presence of the water insoluble polymerization catalyst complex and the additive.

The main functions of the starter compound are to provide molecular weight control and to establish the number of hydroxyl groups that the polyether product will have. A hydroxyl-containing starter compound may contain 1 or more (preferably 2 or more) hydroxyl groups and as many as 12 or more hydroxyl groups. For example, starters for producing polyols for use in polyurethane applications usually have from 2 to 8 hydroxyl groups per molecule. In some embodiments, the starter compound will have from 2 to 4 or from 2 to 3 hydroxyl groups. In other embodiments, the starter compound will have from 4 to 8 or from 4 to 6 hydroxyl groups. The starter compound may have at least two hydroxyl groups that are in the 1,2- or 1,3-positions with respect to each other (taking the carbon atom to which one of the hydroxyl groups is bonded as the “1” position). Mixtures of starter compounds can be used.

The starter compound will have a hydroxyl equivalent weight less than that of the monol or polyol product. It may have a hydroxyl equivalent weight of from 30 to 500 g/equivalent or more, as determined by measuring hydroxyl number according to ASTM D4274-21 and converting hydroxyl number in mg KOH/g to equivalent weight using the relation equivalent weight=56,100÷hydroxyl number. The equivalent weight may be up to 500, up to 250, up to 125, and/or up to 100 g/equivalent.

Exemplary starters include, but are not limited to, glycerin, ethylene glycol, diethylene glycol, triethylene glycol, propylene glycol, dipropylene glycol, tripropylene glycol, 1,4-butane diol, 1,6-hexane diol, 1,8-octane diol, cyclohexane dimethanol, glycerin, trimethylolpropane, trimethylolethane, pentaerythritol, sorbitol, sucrose, phenol and polyphenolic starters such as bisphenol A or 1,1,1-tris(hydroxyphenyl)ethane, and alkoxylates (such as ethoxylates and/or propoxylates) of any of these that have a hydroxyl equivalent weight less than that of the product of the polymerization. The starter compound can also be water. The starter may be neutralized with or contain a small amount of an acid, particularly if the starter is prepared in the presence of a base (as is often the case with glycerin). If an acid is present, it may be present in an amount of from about 10 to 100 ppm, based on the weight of the starter, e.g., as described in U.S. Pat. No. 6,077,978. The acid may be used in somewhat larger amounts, such as from 100 to 1000 ppm, based on the weight of the starter, as described in U.S. Patent Publication Application No. 2005-0209438. The acid may be added to the starter before or after the starter is combined with the catalyst complex.

Certain starters may provide specific advantages. Triethylene glycol has been found to be an especially good starter for use in batch and semi-batch processes for producing polyether diols. Tripropylene glycol and dipropylene glycol also have been found to be especially good starters for use in conjunction with the catalyst complex of the invention.

The alkylene oxide may be, e.g., ethylene oxide, 1,2-propylene oxide, 2,3-propylene oxide, 1,2-butane oxide, 2-methyl-1,2-butaneoxide, 2,3-butane oxide, tetrahydrofuran, epichlorohydrin, hexane oxide, styrene oxide, divinylbenzene dioxide, a glycidyl ether such as bisphenol A diglycidyl ether, allyl glycidyl ether, another polymerizable oxirane, or a mixture of any two or more of these. In some specific embodiments the alkylene oxide is 1,2-propylene oxide, or a mixture of at least 40% (preferably at least 80%) by weight 1,2-propylene oxide and up to 60% by weight (preferably up to 20%) ethylene oxide. An important advantage of this invention is the catalyst can be activated in the presence of ethylene oxide as the sole or predominant alkylene oxide, and that ethylene oxide can be polymerized facilely even onto low molecular weight starters. Thus, in some embodiments, the alkylene oxide is ethylene oxide or a mixture of at least 60% or at least 80% by weight ethylene oxide, and correspondingly up to 40% or up to 20% 1,2-propylene oxide.

The reaction mixture in some embodiments contains 1 to 25 wt. % hydroxyl groups, based on the total weight of the reaction mixture. The reaction mixture may contain, for example, 4.5 to 20 wt. %, 4.5 to 15 wt. %, 4.5 to 12 wt. % or 4.5 to 10 wt. % hydroxyl groups for at least a portion of the polymerization reaction.

The reaction mixture in some embodiments contains up to 10 wt. % ethylene oxide. The reaction mixture may contain, for example, up to 8 wt. %, up to 6 wt. % or up to 5 wt. % ethylene oxide at a point in the polymerization in which the ethylene oxide content (if any) is at its highest. In some embodiments, the reaction mixture contains, for at least a portion of the polymerization reaction, at least 2 wt. % or at least 3 wt. % of ethylene oxide.

The components that make up the reaction mixture may be combined in any order.

The polymerization typically is performed at an elevated temperature. The polymerization mixture temperature may be, for example, 80 to 220° C. (e.g., from 120 to 190° C.).

The polymerization reaction usually is performed at superatmospheric pressure, but can be performed at atmospheric pressure or even sub-atmospheric pressures. A preferred pressure is 0 to 10 atmospheres (0 to 1013 kPa), especially 0 to 6 atmospheres (0 to 608 kPa), gauge pressure.

The polymerization preferably is performed under vacuum or under an inert atmosphere such as a nitrogen, helium or argon atmosphere.

Enough of the water insoluble polymerization catalyst complex may be used to provide a reasonable polymerization rate, but it is generally desirable to use as little of the catalyst complex as possible consistent with reasonable polymerization rates, as this both reduces the cost for the catalyst and, if the catalyst levels are low enough, can eliminate the need to remove catalyst residues from the product. Using lower amounts of catalysts also reduces the residual metal content of the product. The amount of catalyst complex may be from 1 to 5000 ppm based on the weight of the product. The amount of catalyst complex may be at least 2 ppm, at least 5 ppm, at least 10 ppm, at least 25 ppm, or up to 500 ppm or up to 200 ppm or up to 100 ppm, based on the weight of the product. When the catalyst complex contains a hexacyanocobaltate compound, the amount of catalyst complex may be selected to provide 0.25 to 20, 0.5 to 10, 0.5 to 1 or 0.5 to 2.5 parts by weight cobalt per million parts by weight of the product.

The polymerization reaction may be performed in any type of vessel that is suitable for the pressures and temperatures encountered. In a continuous or semi-batch process, alkylene oxide, additional starter compound and preferably the water insoluble polymerization catalyst complex, promoter (if used) and additive are introduced as the polymerization proceeds. Accordingly, the vessel should have one or more inlets through which those components can be introduced during the reaction. In a continuous process, the reactor vessel should contain at least one outlet through which a portion of the partially polymerized reaction mixture can be withdrawn. In a semi-batch operation, alkylene oxide (and optionally additional starter and catalyst complex) is added during the reaction, but product usually is not removed until the polymerization is completed. A tubular reactor that has multiple points for injecting the starting materials, a loop reactor, and a continuous stirred tank reactor (CTSR) are all suitable types of vessels for continuous or semi-batch operations. The reactor should be equipped with a means of providing or removing heat, so the temperature of the reaction mixture can be maintained within the required range. Suitable means include various types of jacketing for thermal fluids, various types of internal or external heaters, and the like. A cook-down step performed on continuously withdrawn product is conveniently conducted in a reactor that prevents significant back-mixing from occurring. Plug flow operation in a pipe or tubular reactor is a preferred manner of performing such a cook-down step.

The product obtained in any of the foregoing processes may contain up to 0.5% by weight, based on the total weight, of unreacted alkylene oxide; small quantities of the starter compound and low molecular weight alkoxylates thereof; and small quantities of other organic impurities and water. Volatile impurities should be flashed or stripped from the resultant polyether. The product typically contains catalyst residues and may contain residues of the promoter (if used) and the additive. It is typical to leave these residues in the product, but these can be removed if desired. Moisture and volatiles can be removed by stripping the polyol.

The polymerization reaction can be characterized by the “build ratio”, which is defined as the ratio of the number average molecular weight of the product to that of the starter compound. This build ratio may be as high as 160, but is more commonly in the range of from 2.5 to about 65 and still more commonly in the range of from 2.5 to about 50, from 2.5 to 35, from 2.5 to 11 or from 7 to 11.

The invention is particularly useful in polymerization processes characterized by one or more of the following: i) the use of a starter having an equivalent weight of up to 125, especially up to 100 or up to 75 g/equivalent; ii) a hydroxyl content of 4.25 to 20 wt. %, especially 4.25 to 15 wt. %, 4.25 to 12 wt. % or 4.25 to 10 wt. %, based on the total weight of the reaction mixture, during at least a portion of the polymerization process, iii) a concentration of catalyst complex sufficient to provide at most 5 ppm of cobalt, especially 0.5 to 2 ppm cobalt, based on the weight of the product, iv) the alkylene oxide is ethylene oxide or a mixture of alkylene oxides that contains at least 60% or at least 80% by weight ethylene oxide (the balance preferably being 1,2-propylene oxide) and (v) an ethylene oxide concentration of 2 to 10 wt. %, 2 to 8 wt. %, 2 to 6 wt. % or 2 to 5 wt. % at a point in the polymerization in which the ethylene oxide content (if any) is at its highest. Each of these represents a severe condition in which conventional zinc hexacyanometallate catalysts perform poorly.

In some embodiments, the polymerization step is performed in the presence of no more than 0.01 mole of a carbonate precursor per mole of alkylene oxide that is polymerized. A “carbonate” precursor is a compound that gives rise to carbonate (—O—C(O)—O—) linkages when polymerized with an alkylene oxide. Examples of carbonate precursors include carbon dioxide, linear carbonates, cyclic carbonates, phosgene and the like.

The water insoluble polymerization catalyst complex includes at least one double metal cyanide compound. Polymerization catalyst complexes of this type, and double metal cyanide compounds generally, are well known and include, for example, those described in U.S. Pat. Nos. 3,278,457, 3,278,458, 3,278,459, 3,404,109, 3,427,256, 3,427,334, 3,427,335, and 5,470,813, among many others. In some embodiments, the double metal cyanide compound is represented by the formula:

M¹_{b}[M²(CN)ᵣ(X¹)ₜ]_{c}[M³(X²)₆]_{d}·nM⁴ₓA¹_{y} (I)

wherein:
M¹ and M⁴ each represent a metal ion independently selected from Zn²⁺, Fe²⁺, Co⁺²⁺, Ni²⁺, Mo⁴⁺, Mo⁶⁺, Al³⁺, V⁴⁺, V⁵⁺, Sr²⁺, W⁴⁺, W⁶⁺, Mn²⁺, Sn²⁺, Sn⁴⁺, Pb²⁺, Cu²⁺, La³⁺, and Cr³⁺;
M² and M³ each represent a metal ion independently selected from Fe³⁺, Fe²⁺, Co³⁺, Co²⁺, Cr²⁺, Cr³⁺, Mn²⁺, Mn³⁺, Ir³⁺, Ni²⁺, Rh³⁺, Ru²⁺, V⁴⁺, V⁵⁺, Ni²⁺, Pd²⁺, and Pt²⁺;
X¹ represents a group other than cyanide that coordinates with the M² ion;
X² represents a group other than cyanide that coordinates with the M³ ion;
A¹ represents a halide such as chloride, bromide and iodide; nitrate; sulfate; carbonate; cyanide; oxalate; thiocyanate; isocyanate; perchlorate; isothiocyanate; an alkanesulfonate such as methanesulfonate; an arylenesulfonate such as p-toluenesulfonate; and trifluoromethanesulfonate (triflate);
b, c and d are each numbers such that the M¹_{b}[M²(CN)ᵣ(X¹)ₜ]_{c}[M³(X²)₆]_{d} group reflect an electrostatically neutral, provided that b and c each are greater than zero;
x and y are integers such that the metal salt M⁴ₓA¹_{y} is electrostatically neutral;
r is an integer from 4 to 6;
t is an integer from 0 to 2; and
n is a number from 0 and 20.

M¹ and M⁴ (if present) each most preferably are zinc. M² and M³ (if present) each most preferably are iron and cobalt, especially cobalt. r is most preferably 6 and t is most preferably zero. d is most preferably 0 to 1. The mole ratio of the M¹ metal and the M⁴ metal combined to the M² and the M³ metal combined is preferably 0.8:1 to 20:1.

In some embodiments p may be at least 0.001 at least 0.0025 and may be up to 10, up to 5, up to 1.5, up to 0.25 or up to 0.125. In some embodiments q may be at least 0.002, at least 0.01, at least 0.025 or at least 0.05 and may be up to 10, up to 2 up to 1.25 or up to 0.5. Smaller values of p and q do not lead to any improvement in the performance of the catalyst complex. Larger amounts not only fail to improve the catalyst performance but actually tend to diminish it.

In some embodiments, the ratio p:q may be at least 0.025 or at least 0.05 and up to 1.5, up to 1 or up to 0.5.

The values of p, q and the ratio p:q are conveniently determined using X-ray fluorescence (XRF) methods.

Catalyst complexes of the foregoing formula can be made in a precipitation process in which a solution containing the starting materials, including a cyanometallate compound and a starting M¹ compound is prepared, certain of the starting materials react and the catalyst complex precipitates from the starting solution. In general, methods for producing DMC catalysts as described, e.g., in U.S. Pat. Nos. 3,278,457, 3,278,458, 3,278,459, 3,404,109, 3,427,256, 3,427,334, 3,427,335, and 5,470,813.

The solvent includes at least one of water and a liquid aliphatic alcohol. The solvent is one in which the starting cyanometallate compound and M¹ metal compound are soluble.

The solvent may be, for example, water, n-propanol, iso-propanol, n-butanol, sec-butanol, t-butanol, other alkylene monoalcohol having up to, for example, 12 carbon atoms, ethylene glycol, diethylene glycol, triethylene glycol, propylene glycol, dipropylene glycol, tripropylene glycol, or other polyether having one or more hydroxyl groups and a number average molecular weight of up to, for example, 8000 g/mol as measured by gel permeation chromatography against polystyrene standards. Aliphatic monoalcohols having 3 to 6 carbon atoms, especially t-butanol, are preferred among these. Especially preferred is a mixture of water and a liquid aliphatic alcohol that is soluble in water at the relative proportions present in the mixture (especially an aliphatic monoalcohol having 3 to 6 carbon atoms and most preferably t-butanol), in a volume ratio of 25:75 to 90:10.

The M¹ metal compound preferably is water-soluble. It is typically a salt of an M¹ metal and one or more anions. Such a salt may have the formula M¹ₓA¹_{y}, wherein x, A¹ and y are as described before. In exemplary embodiments, the anion A¹ is not any of alkoxide, aryloxy, carboxylate, acyl, pyrophosphate, phosphate, thiophosphate, dithiophosphate, phosphate ester, thiophosphate ester, amide, oxide, siloxide, hydride, carbamate or hydrocarbon anion.

The M¹ metal is one or more of Zn²⁺, Fe²⁺, Co⁺²⁺, Ni²⁺, Mo⁴⁺, Mo⁶⁺, Al⁺³⁺, V⁴⁺, V⁵⁺, Sr²⁺, W⁴⁺, W⁶⁺, Mn²⁺, Sn²⁺, Sn⁴⁺, Pb²⁺, Cu²⁺, La³⁺ and Cr³⁺. Zn²⁺ is the preferred M¹ metal. ZnCl₂ is a preferred M¹ metal compound.

The cyanometallate compound includes an M²(CN)ᵣ(X¹)ₜ anion, where r, X¹ and t are as described before. r is preferably 6 and t is preferably zero. The M² metal is one or more of Fe³⁺, Fe²⁺, Co³⁺, Co²⁺, Cr²⁺, Cr³⁺, Mn²⁺, Mn³⁺, Ir³⁺, Ni²⁺, Rh³⁺, Ru²⁺, V⁴⁺, V⁵⁺, Ni²⁺, Pd²⁺, and Pt²⁺. The M² metal preferably is Fe³⁺ or Co³⁺, with Co³⁺ being especially preferred. The cyanometallate compound preferably is an alkali metal or ammonium salt, although the corresponding cyanometallitic acid can be used. Potassium hexacyanocobaltate is a particularly preferred cyanometallate compound.

The cyanometallate compound and M¹ metal compound react to form a catalyst complex that includes a water-insoluble M¹ metal cyanometallate. This reaction proceeds spontaneously at temperatures around room temperature (23° C.) or slightly elevated temperatures. Therefore, no special reaction conditions are needed. The temperature may be, for example, from 0 to 60° C. A preferred temperature is 20 to 50° C. or 25 to 45° C. It is preferred to continue agitation until precipitation takes place, which is generally indicated by a change of appearance in the solution. The reaction pressure is not especially critical so long as the solvent does not boil off. An absolute pressure of 10 to 10,000 kPa is suitable, with an absolute pressure of 50 to 250 kPa being entirely suitable. The reaction time may be from 30 minutes to 24 hours or more.

It is preferred to treat the precipitated double metal cyanide with a complexing agent, which becomes incorporated into the catalyst complex. This is conveniently done by washing the precipitated double metal cyanide one or more times with a complexing agent or solution of the complexing agent in water. The complexing agent component may include at least one of an alcohol as described before with regard to the starting solution, a polyether, a polyester, a polycarbonate, a glycidyl ether, a glycoside, a polyhydric alcohol carboxylate, a polyalkylene glycol sorbitan ester, a bile acid or salt, a carboxylic acid ester or amide thereof, cyclodextrin, an organic phosphate, a phosphite, a phosphonate, a phosphonite, a phosphinate, a phosphinite, an ionic surface- or interface-active compound, and/or an α,β-unsaturated carboxylic acid ester. In exemplary embodiments, the organic complex agent is one or more of n-propanol, iso-propanol, n-butanol, sec-butanol, t-butanol, other alkylene monoalcohol having up to 12 carbon atoms, ethylene glycol, diethylene glycol, triethylene glycol, propylene glycol, dipropylene glycol, tripropylene glycol, or other polyether having one or more hydroxyl groups and a number average molecular weight of up to, for example, 8000 g/mol as measured by gel permeation chromatography against polystyrene standards.

The catalyst complex so made is conveniently recovered from the starting solution or any wash liquid, dried and, if desired, ground or milled to reduce the catalyst complex to a powder having a volume average particle size of, for example, 100 m or smaller. Drying can be performed by heating and/or applying vacuum.

The additive in some embodiments is or includes an alkali metal, ammonium or quaternary ammonium salt of a monocarboxylic acid having up to 24 carbon atoms. The monocarboxylic acid may have 1 to 18 carbon atoms, 1 to 12 carbon atoms, 1 to 8 carbon atoms or 1 to 2 carbon atoms. The monocarboxylic acid may be aliphatic and may be linear; in other embodiments the monocarboxylic acid may be aromatic (such as benzoic acid). The alkali metal may be lithium, sodium, potassium and/or cesium. By “ammonium”, it is meant NH₄⁺ ion. A quaternary ammonium ion takes the form NR⁴⁺, wherein each R is independently H or hydrocarbyl, provided at least one R is hydrocarbyl. Specific examples include lithium, sodium, potassium, cesium or ammonium formate; lithium, sodium, potassium, cesium or ammonium acetate; lithium, sodium, potassium, cesium or ammonium benzoate, and lithium, sodium, potassium, cesium or ammonium salts of a linear or branched aliphatic C4-C18 monocarboxylic acid.

The additive may be or include one or more of a monobasic alkali metal phosphate, monobasic ammonium phosphate and a monobasic quaternary ammonium phosphate. Examples of these include lithium dihydrogen phosphate, sodium dihydrogen phosphate, potassium dihydrogen phosphate, cesium dihydrogen phosphate and ammonium dihydrogen phosphate.

The additive may be or include dibasic sodium phosphate (Na₂HPO₄).

The additive may be or include one or more of tartaric acid, malic acid or succinic acid.

The weight of additive in some embodiments is from 1 to 25 times that of the catalyst complex. The additive weight may be, for example, at least 2 times or at least 3 times the weight of the catalyst complex. The additive weight may be up to 15 times, up to 10 times, up to 7.5 times or up to 5 times the weight of the catalyst complex.

Expressed alternatively, the additive is conveniently present in the polymerization mixture in an amount of about 50 to 50,000 parts per million by weight (ppm), based on the weight of the product. A preferred lower amount is at least 100 ppm, at least 250 ppm, at least 500 ppm or at least 1000 ppm. A preferred upper amount is up to 10,000 ppm, up to 5,000 ppm, up to 2500 ppm or up to 1500 ppm.

A promoter is optionally present in the reaction mixture. The promoter for purposes of this invention is a component separate from the water insoluble polymerization catalyst complex, which for purposes of this invention, means neither the promoter nor an M⁵ metal or semi-metal-containing precursor is present during a precipitation step that form the double metal cyanide component of the catalyst complex. The promoter may be combined with the other ingredients in any order, and in particular may be combined with the catalyst complex prior to being combined with the other components of the polymerization mixture.

The M⁵ metal or semi-metal compound is a compound of magnesium or a metal or semi-metal M⁵ that falls within any of Groups 3 through 15, inclusive, of the 2010 IUPAC periodic table of the elements, and one or more anions selected from the group consisting of alkoxide, aryloxy, carboxylate, acyl, pyrophosphate, phosphate, thiophosphate, dithiophosphate, phosphate ester, thiophosphate ester, amide, oxide, siloxide, hydride, carbamate, halide or hydrocarbon anions.

The metal may be, e.g., scandium, yttrium, lanthanum, zirconium, hafnium, vanadium, niobium, tantalum, chromium, molybdenum, tungsten, manganese, rhenium, iron, ruthenium, osmium, cobalt, rhodium, iridium, nickel, titanium, silicon, palladium, platinum, copper, silver, gold, zinc, cadmium, mercury, aluminum, gallium, indium, tellurium, tin, lead, bismuth, and the lanthanide series metals including those having atomic numbers from 58 (cerium) to 71 (lutetium), inclusive.

Preferred M⁵ metals and semi-metals include yttrium, zirconium, nobium, silicon, titanium, tungsten, cobalt, scandium, vanadium, molybdenum, nickel, zinc and tin. More preferred are hafnium, aluminum, manganese, gallium and indium.

By “alkoxide” ion it is meant a species having the form —O—R, where R is an alkyl group or substituted alkyl group, and which is the conjugate base, after removal of a hydroxyl hydrogen, of an alcohol compound having the form HO—R. These alcohols may have pKa values in the range of 13 to 25 or greater. The alkoxide ion in some embodiments may contain 1 to 20 (e.g., 1 to 6 and/or 2 to 6) carbon atoms. The alkyl group or substituted alkyl group may be linear, branched, and/or cyclic. Examples of suitable substituents include, e.g., additional hydroxyl groups (which may be in the alkoxide form), ether groups, carbonyl groups, ester groups, urethane groups, carbonate groups, silyl groups, aromatic groups such as phenyl and alkyl-substituted phenyl, and halogens. Examples of such alkoxide ions include methoxide, ethoxide, isopropoxide, n-propoxide, n-butoxide, sec-butoxide, t-butoxide, and benzyloxy. The R group may contain one or more hydroxyl groups and/or may contain one or more ether linkages. An alkoxide ion may correspond to the residue (after removal of one or more hydroxyl hydrogens) of a starter compound that is present in the polymerization, such as those starter compounds described below. The alkoxide ion may be an alkoxide formed by removing one or more hydroxyl hydrogens from a polyether monol or polyether polyol; such an alkoxide in some embodiments corresponds to a residue, after removal of one or more hydroxyl hydrogen atoms, of the polyether monol or polyether polyol product that is obtained from the alkoxylation reaction, or of a polyether having a molecular weight intermediate to that of the starter compound and the product of the alkoxylation reaction.

By “aryloxy” anion it is meant a species having the form —O—Ar, where Ar is an aromatic group or substituted aromatic group, and which corresponds, after removal of a hydroxyl hydrogen, to a phenolic compound having the form HO—Ar. These phenolic compounds may have a pKa of, e.g., 9 to about 12. Examples of such aryloxy anions include phenoxide and ring-substituted phenoxides, in which the ring-substituents include, e.g., one or more of alkyl, CF₃, cyano, COCH₃, halogen, hydroxyl, and alkoxyl. The ring-substituent(s), if present, may be in one or more of the ortho-, para- and/or meta-positions relative to the phenolic group. The phenoxide anions also include the conjugate bases of polyphenolic compounds such as bisphenol A, bisphenol F and various other bisphenols, 1,1,1-tris(hydroxyphenyl)ethane, and fused ring aromatics such as 1-naphthol.

By “carboxylate” anion it is meant a carboxylate that contains 1 to 24 (e.g., 2 to 18 and/or 2 to 12) carbon atoms. The carboxylate may be aliphatic or aromatic. An aliphatic carboxylic acid may contain substituent groups. Examples of such include hydroxyl groups (which may be in the alkoxide form), ether groups, carbonyl groups, ester groups, urethane groups, carbonate groups, silyl groups, aromatic groups such as phenyl and alkyl-substituted phenyl, and halogens. Examples of aliphatic carboxylate anions include formate, acetate, propionate, butyrate, 2-ethylhexanoate, n-octoate, decanoate, laurate and other alkanoates and halogen-substituted alkanoates such as 2,2,2-trifluoroacetate, 2-fluoroacetate, 2,2-difluoroacetate, 2-chloroacetate, and 2,2,2-trichloroacetate. Examples of aromatic carboxylates include benzoate, alkyl-substituted benzoate, halo-substituted benzoate, 4-cyanobenzoate, 4-trifluoromethylbenzoate, salicylate, 3,5-di-t-butylsalicylate, and subsalicylate. In some embodiments, such a carboxylate ion may be the conjugate base of a carboxylic acid having a pKa 1 to 6 (e.g., 3 to 5).

By “acyl” anion it is meant a conjugate base of a compound containing a carbonyl group including, e.g., an aldehyde, ketone, acetylacetonate, carbonate, ester or similar compound that has an enol form. Examples of these are ß-diketo compounds, such as acetoacetonate and butylacetoacetonate.

By “phosphate” anion it is meant a phosphate anion that has the formula —O—P(O)(OR¹)₂, wherein R¹ is alkyl, substituted alkyl, phenyl, or substituted phenyl.

By “thiophosphate” anion it is meant thiophosphate anions have the corresponding structure in which one or more of the oxygens are replaced with sulfur. The phosphate and thiophosphates may be ester anions, such as phosphate ester and thiophosphate ester.

By “pyrophosphate” anion it is meant the P₂O₇⁴⁻ anion.

By “amide” anion it is meant an ion in which a nitrogen atom bears a negative charge. The amide ion generally takes the form —N(R²)₂, wherein the R² groups are independently hydrogen, alkyl, aryl, trialkylsilyl, or triarylsilyl. The alkyl groups may be linear, branched, or cyclic. Any of these groups may contain substituents such as ether or hydroxyl. The two R² groups may together form a ring structure, which ring structure may be unsaturated and/or contain one or more heteroatoms (in addition to the amide nitrogen) in the ring.

By “oxide” anion is meant the anion of atomic oxygen, i.e., O²⁻.

By “siloxide” anion it is meant silanoates having the formula (R³)₃SiO—, wherein R³ groups are independently hydrogen or alkyl group.

By “hydride” anion it is meant the anion of hydrogen, i.e., H—

By “carbamate” anion it is meant the anion —OOCNH₂.

By “hydrocarbon” anion it is meant hydrocarbyl anions that include aliphatic, cycloaliphatic and/or aromatic anions wherein the negative charge resides on a carbon atom. The hydrocarbyl anions are conjugate bases of hydrocarbons that typically have pKa values in excess of 30. The hydrocarbyl anions may also contain inert substituents. Of the aromatic hydrocarbyl anions, phenyl groups and substituted phenyl groups may be used. Aliphatic hydrocarbyl anions may be alkyl groups which may contain, for example, 1 to 12 (e.g., 2 to 8) carbon atoms. For example, methyl, ethyl, n-propyl, isopropyl, n-butyl, sec-butyl, isobutyl, cyclopentadienyl and t-butyl anions are all useful.

By “halide” anion it is meant F⁻, Cl⁻, Br⁻ and I⁻.

Examples of useful gallium compounds include trialkyl gallium compounds such as trimethylgallium, triethyl gallium, tributyl gallium, tribenzylgallium and the like; gallium oxide; gallium alkoxides such as gallium trimethoxide, gallium triethoxide, gallium triisopropoxide, gallium tri-t-butoxide, gallium tri-sec-butoxide and the like; gallium aryloxides such as gallium phenoxide and gallium phenoxides in which one or more of the phenoxide groups is ring-substituted with one or more of alkyl, CF₃, cyano, COCH₃, halogen, hydroxyl, alkoxyl and the like; gallium carboxylates such as gallium formate, gallium acetate, gallium propionate, gallium 2-ethylhexanoate, gallium benzoate, gallium benzoates in which one or more of the benzoate groups is ring-substituted with one or more of alkyl, CF₃, cyano, COCH₃, halogen, hydroxyl, alkoxyl and the like, gallium salicylate, gallium 3,5-di-t-butyl salicylate; gallium amides such as gallium tris(dimethylamide), gallium tris(diethylamide), gallium tris(diphenylamide), gallium tris(di(trimethylsilyl)amide) and the like; gallium acetylacetonate; gallium t-butylacetylacetonate; and alkylgallium alkoxides such as diethylgallium ethoxide, dimethylgallium ethoxide, diethylgallium isopropoxide and dimethylgallium isopropoxide.

Examples of useful hafnium compounds include hafnium alkyls such as such as tetraethyl hafnium, tetrabutyl hafnium, tetrabenzyl hafnium and the like; hafnium oxide; hafnium alkoxides such as hafnium tetramethoxide, hafnium tetraethoxide, hafnium tetraisopropoxide, hafnium tetra-t-butoxide, hafnium tetra-sec-butoxide and the like; hafnium aryloxides such as hafnium phenoxide and hafnium phenoxides in which one or more of the phenoxide groups is ring-substituted with one or more of alkyl, CF₃, cyano, COCH₃, halogen, hydroxyl, alkoxyl and the like; hafnium carboxylates such as hafnium formate, hafnium acetate, hafnium propionate, hafnium 2-ethylhexanoate, hafnium benzoate, hafnium benzoates in which one or more of the benzoate groups is ring-substituted with one or more of alkyl, CF₃, cyano, COCH₃, halogen, hydroxyl, alkoxyl and the like, hafnium salicylate, hafnium 3,5-di-t-butyl salicylate; hafnium amides such as hafnium tetra(dimethylamide), hafnium tetra(diethylamide), hafnium tetra(diphenylamide), hafnium tetra((bistrimethylsilyl)amide); hafnium acetylacetonate and hafnium t-butylacetylacetonate.

Examples of useful indium compounds include trialkyl indium compounds like trimethyl indium; indium oxide; indium alkoxides such as indium methoxide, indium ethoxide, indium isopropoxide, indium t-butoxide, indium sec-butoxide and the like; indium aryloxides such as indium phenoxide and indium phenoxides in which one or more of the phenoxide groups is ring-substituted with one or more of alkyl, CF₃, cyano, COCH₃, halogen, hydroxyl, alkoxyl and the like; indium carboxylates such as indium formate, indium acetate, indium propionate, indium 2-ethylhexanoate, indium benzoate, indium benzoates in which one or more of the benzoate groups is ring-substituted with one or more of alkyl, CF₃, cyano, COCH₃, halogen, hydroxyl, alkoxyl and the like, indium salicylate, indium 3,5-di-t-butyl salicylate; indium acetylacetonate; and indium t-butylacetylacetonate.

Examples of useful aluminum compounds include trialkyl aluminum compounds such as trimethylaluminum, triethyl aluminum, tributyl aluminum, tribenzylaluminum and the like; aluminum alkoxides such as aluminum trimethoxide, aluminum triethoxide, aluminum triisopropoxide, aluminum tri-t-butoxide, aluminum tri-sec-butoxide and the like; aluminum aryloxides such as aluminum phenoxide and aluminum phenoxides in which one or more of the phenoxide groups is ring-substituted with one or more of alkyl, CF₃, cyano, COCH₃, halogen, hydroxyl, alkoxyl and the like; aluminum oxide; aluminum carboxylates such as aluminum formate, aluminum acetate, aluminum propionate, aluminum 2-ethylhexanoate, aluminum benzoate, aluminum benzoates in which one or more of the benzoate groups is ring-substituted with one or more of alkyl, CF₃, cyano, COCH₃, halogen, hydroxyl, alkoxyl and the like, aluminum salicylate, aluminum 3,5-di-t-butyl salicylate; aluminum amides such as aluminum tris(dimethylamide), aluminum tris(diethylamide), aluminum tris(diphenylamide), aluminum tris(di(trimethylsilyl)amide) and the like; aluminum acetylacetonate; aluminum t-butylacetylacetonate; and alkylaluminum oxides and alkoxides such as diethylaluminum ethoxide, dimethylaluminum ethoxide, diethylaluminum isopropoxide, dimethylaluminum isopropoxide, methyl aluminoxane, tetraethyldialuminoxane and the like.

Examples of useful magnesium compounds include magnesium alkyls such as diethyl magnesium, dibutyl magnesium, butylethyl magnesium, dibenzyl magnesium and the like; magnesium alkoxides such as magnesium methoxide, magnesium ethoxide, magnesium isopropoxide, magnesium t-butoxide, magnesium sec-butoxide and the like; magnesium aryloxides such as magnesium phenoxide, and magnesium phenoxides in which one or more of the phenoxide groups is ring-substituted with one or more of alkyl, CF₃, cyano, COCH₃, halogen, hydroxyl, alkoxyl and the like; magnesium carboxylates such as magnesium formate, magnesium acetate, magnesium propionate, magnesium 2-ethylhexanoate, magnesium benzoate, magnesium benzoates in which one or more of the benzoate groups is ring-substituted with one or more of alkyl, CF₃, cyano, COCH₃, halogen, hydroxyl, alkoxyl and the like, magnesium salicylate, magnesium 3,5-di-t-butyl salicylate; magnesium amides such as magnesium dimethylamide, magnesium diethylamide, magnesium diphenylamide, magnesium bis(trimethylsilyl)amide and the like; magnesium oxide, magnesium acetylacetonate and magnesium t-butylacetylacetonate

Examples of useful manganese compounds include Mn(II) and/or Mn(III) and/or Mn(IV) compounds include manganese phosphate; pyrophosphate, manganese oxide; manganese alkoxides such as manganese methoxide, manganese ethoxide, manganese isopropoxide, manganese t-butoxide, manganese sec-butoxide and the like; manganese aryloxides such as manganese phenoxide and manganese phenoxides in which one or more of the phenoxide groups is ring-substituted with one or more of alkyl, CF₃, cyano, COCH₃, halogen, hydroxyl, alkoxyl and the like; manganese carboxylates such as manganese formate, manganese acetate, manganese propionate, manganese 2-ethylhexanoate, manganese benzoate, manganese benzoates in which one or more of the benzoate groups is ring-substituted with one or more of alkyl, CF₃, cyano, COCH₃, halogen, hydroxyl, alkoxyl and the like, manganese salicylate, manganese 3,5-di-t-butyl salicylate; manganese acetylacetonate; and manganese t-butylacetylacetonate.

Examples of useful scandium compounds include scandium alkoxides such as scandium methoxide, scandium ethoxide, scandium isopropoxide, scandium t-butoxide, scandium sec-butoxide and the like; scandium oxide; scandium aryloxides such as scandium phenoxide and scandium phenoxides in which one or more of the phenoxide groups is ring-substituted with one or more of alkyl, CF₃, cyano, COCH₃, halogen, hydroxyl, alkoxyl and the like; scandium carboxylates such as scandium formate, scandium acetate, scandium propionate, scandium 2-ethylhexanoate, scandium benzoate, scandium benzoates in which one or more of the benzoate groups is ring-substituted with one or more of alkyl, CF₃, cyano, COCH₃, halogen, hydroxyl, alkoxyl and the like; scandium salicylate; scandium acetylacetonate and scandium t-butylacetylacetonate.

Examples of useful molybdenum compounds include Mo(IV) and/or Mo(VI) compounds such as molybdenum phosphate; molybdenum pyrophosphate, molybdenum oxide; molybdenum alkoxides such as molybdenum methoxide, molybdenum ethoxide, molybdenum isopropoxide, molybdenum t-butoxide, molybdenum sec-butoxide and the like; molybdenum aryloxides such as molybdenum phenoxide and molybdenum phenoxides in which one or more of the phenoxide groups is ring-substituted with one or more of alkyl, CF₃, cyano, COCH₃, halogen, hydroxyl, alkoxyl and the like; molybdenum carboxylates such as molybdenum formate, molybdenum acetate, molybdenum propionate, molybdenum 2-ethylhexanoate, molybdenum benzoate, molybdenum benzoates in which one or more of the benzoate groups is ring-substituted with one or more of alkyl, CF₃, cyano, COCH₃, halogen, hydroxyl, alkoxyl and the like, molybdenum salicylate, molybdenum 3,5-di-t-butyl salicylate; molybdenum acetylacetonate.

Examples of useful cobalt compounds include Co (II) and/or Co(III) compounds such as cobalt phosphate; cobalt pyrophosphate, cobalt oxide; cobalt alkoxides such as cobalt methoxide, cobalt ethoxide, cobalt isopropoxide, cobalt t-butoxide, cobalt sec-butoxide and the like; cobalt aryloxides such as cobalt phenoxide and cobalt phenoxides in which one or more of the phenoxide groups is ring-substituted with one or more of alkyl, CF₃, cyano, COCH₃, halogen, hydroxyl, alkoxyl and the like; cobalt carboxylates such as cobalt formate, cobalt acetate, cobalt propionate, cobalt 2-ethylhexanoate, cobalt benzoate, cobalt benzoates in which one or more of the benzoate groups is ring-substituted with one or more of alkyl, CF₃, cyano, COCH₃, halogen, hydroxyl, alkoxyl and the like, cobalt salicylate, cobalt 3,5-di-t-butyl salicylate; cobalt acetylacetonate; and cobalt t-butylacetylacetonate, in each case being a Co(II) and/or Co(III) compound.

Examples of useful tungsten compounds include tungsten phosphate; tungsten pyrophosphate, tungsten oxide; tungsten alkoxides such as tungsten methoxide, tungsten ethoxide, tungsten isopropoxide, tungsten t-butoxide, tungsten sec-butoxide and the like; tungsten aryloxides such as tungsten phenoxide and tungsten phenoxides in which one or more of the phenoxide groups is ring-substituted with one or more of alkyl, CF₃, cyano, COCH₃, halogen, hydroxyl, alkoxyl and the like; tungsten carboxylates such as tungsten formate, tungsten acetate, tungsten propionate, tungsten 2-ethylhexanoate, tungsten benzoate, tungsten benzoates in which one or more of the benzoate groups is ring-substituted with one or more of alkyl, CF₃, cyano, COCH₃, halogen, hydroxyl, alkoxyl and the like, tungsten salicylate, tungsten 3,5-di-t-butyl salicylate; tungsten acetylacetonate; and tungsten t-butylacetylacetonate.

Examples of useful iron compounds include iron (II) and/or iron (III) compounds such as iron phosphate; iron pyrophosphate, iron oxide; iron alkoxides such as iron methoxide, iron ethoxide, iron isopropoxide, iron t-butoxide, iron sec-butoxide and the like; iron aryloxides such as iron phenoxide and iron phenoxides in which one or more of the phenoxide groups is ring-substituted with one or more of alkyl, CF₃, cyano, COCH₃, halogen, hydroxyl, alkoxyl and the like; iron carboxylates such as iron formate, iron acetate, iron propionate, iron 2-ethylhexanoate, iron benzoate, iron benzoates in which one or more of the benzoate groups is ring-substituted with one or more of alkyl, CF₃, cyano, COCH₃, halogen, hydroxyl, alkoxyl and the like, iron salicylate, iron 3,5-di-t-butyl salicylate; iron acetylacetonate; and iron t-butylacetylacetonate, in each case being a Fe(II) and/or Fe(III) compound.

Examples of useful vanadium compounds include vanadium alkoxides such as vanadium methoxide, vanadium ethoxide, vanadium isopropoxide, vanadium t-butoxide, vanadium sec-butoxide and the like; vanadium oxide; vanadium oxo tris(alkoxides) such as vanadium oxo tris(methoxide), vanadium oxo tris(ethoxide), vanadium oxo tris(isopropoxide), vanadium oxo tris(t-butoxide), vanadium oxo tris(sec-butoxide) and the like; vanadium aryloxides such as vanadium phenoxide and vanadium phenoxides in which one or more of the phenoxide groups is ring-substituted with one or more of alkyl, CF₃, cyano, COCH₃, halogen, hydroxyl, alkoxyl and the like; vanadium carboxylates such as vanadium formate, vanadium acetate, vanadium propionate, vanadium 2-ethylhexanoate, vanadium benzoate, vanadium benzoates in which one or more of the benzoate groups is ring-substituted with one or more of alkyl, CF₃, cyano, COCH₃, halogen, hydroxyl, alkoxyl and the like, vanadium salicylate, vanadium 3,5-di-t-butyl salicylate; vanadium tris(acetylacetonate) and vanadium tris(t-butylacetylacetonate); vanadium oxo bis(acetylacetonate).

Examples of useful tin compounds include stannous phosphate; stannous pyrophosphate, stannous oxide; stannic oxide; stannous alkoxides such as stannous methoxide, stannous ethoxide, stannous isopropoxide, stannous t-butoxide, stannous sec-butoxide and the like; stannous aryloxides such as stannous phenoxide and stannous phenoxides in which one or more of the phenoxide groups is ring-substituted with one or more of alkyl, CF₃, cyano, COCH₃, halogen, hydroxyl, alkoxyl and the like; stannous carboxylates such as stannous formate, stannous acetate, stannous propionate, stannous 2-ethylhexanoate, stannous benzoate, stannous benzoates in which one or more of the benzoate groups is ring-substituted with one or more of alkyl, CF₃, cyano, COCH₃, halogen, hydroxyl, alkoxyl and the like, stannous salicylate, stannous 3,5-di-t-butyl salicylate; stannous acetylacetonate; and stannous t-butylacetylacetonate.

Examples of useful zinc compounds include zinc alkyls such as such as dimethyl zinc, diethyl zinc, dibutyl zinc, dibenzyl zinc and the like; zinc oxide; alkyl zinc alkoxides such as ethyl zinc isopropoxide; zinc alkoxides such as zinc methoxide, zinc ethoxide, zinc isopropoxide, zinc t-butoxide, zinc sec-butoxide and the like; zinc aryloxides such as zinc phenoxide and zinc phenoxides in which one or more of the phenoxide groups is ring-substituted with one or more of alkyl, CF₃, cyano, COCH₃, halogen, hydroxyl, alkoxyl and the like; zinc carboxylates such as zinc formate, zinc acetate, zinc propionate, zinc 2-ethylhexanoate, zinc benzoate, zinc benzoates in which one or more of the benzoate groups is ring-substituted with one or more of alkyl, CF₃, cyano, COCH₃, halogen, hydroxyl, alkoxyl and the like, zinc salicylate, zinc 3,5-di-t-butyl salicylate; zinc amides such as zinc dimethylamide, zinc diethylamide, zinc diphenylamide, zinc (bistrimethylsilyl)amide; zinc acetylacetonate and zinc t-butylacetylacetonate.

Examples of useful titanium compounds include titanium dioxide and titanium alkoxides having the structure Ti(OR)₄ wherein R is alkyl or phenyl (which may be substituted), such as titanium tetraethoxide, titanium tetraisopropoxide, titanium tetra-t-butoxide, titanium tetra-sec-butoxide, titanium tetraphenoxide, titanium tetraphenoxides in which one or more of the phenoxide groups are independently ring-substituted with one or more of alkyl, CF₃, cyano, COCH₃, halogen, hydroxyl, alkoxyl and the like.

Examples of useful silicon compounds include silica and silicon alkoxides having the structure Si(OR)₄ wherein R is alkyl or phenyl (which may be substituted), such as silicon tetraethoxide, silicon tetraisopropoxide, silicon tetra-t-butoxide, silicon tetra-sec-butoxide, silicon tetraphenoxide, silicon tetraphenoxides in which one or more of the phenoxide groups are independently ring-substituted with one or more of alkyl, CF₃, cyano, COCH₃, halogen, hydroxyl, alkoxyl and the like.

The promoter preferably is present in an amount that provides at least 0.001 or at least 0.0025 moles of M⁵ metal or semi-metal per mole of M² plus M³ metal provided by the double metal cyanide catalyst. The promoter may be present in an amount that provides up to 50, up to 10, up to 5, up to 1.5, up to 0.25 or up to 0.125 moles of M⁵ metal or semi-metal per mole of M² plus M³ metal provided by the double metal cyanide catalyst.

Promoter mixtures of compounds of two or more different M⁵ metals or semi-metals may be present, as described, for example, in WO 2020/131508. In such mixtures, it is preferred that at least one of M⁵ metals or semi-metals is gallium, indium, hafnium or titanium (especially gallium or hafnium), and at least one other M⁵ metal or semi-metal is aluminum, silicon or titanium (especially aluminum).

In certain embodiments, the promoter is present in the form of discrete particles, as is generally the case when the promoter is an M⁵ metal or semi-metal oxide. Such particles may have a surface area of at least 1 m²/g as measured using gas sorption methods. The surface area of such promoter particles may be at least 10 m²/g or at least 100 m²/g, and may be up to, for example, 300 m³/g or more. Their volume average particle size may be 100 m or smaller, 25 μm or smaller, 1 μm or smaller or 500 nm or smaller. Such physical admixtures can be made by, for example, forming solid particles of the double metal cyanide catalyst (or catalyst complex containing the double metal cyanide) and combining them with the promoter particles. This can be done at any stage of the catalyst complex preparation process after the double metal cyanide has precipitated. For example, it is common to wash a precipitated double metal cyanide with water and/or a ligand one or more times before final drying. The promoter particles can be combined with the zinc hexacyanocobaltate during any such washing step.

Polyethers made in accordance with the invention may include monoalcohols such as are useful for surfactant and industrial solvent or lubricant applications, and polyols such as are useful raw materials for producing polymers such as polyurethanes such as molded foams, slabstock foams, high resiliency foams, viscoelastic foams, rigid foams, adhesives, sealants, coatings, elastomers, composites, etc.

The following examples are provided to illustrate exemplary embodiments and are not intended to limit the scope thereof. All parts and percentages are by weight unless otherwise indicated.

### EXAMPLES 1-12 AND COMPARATIVE SAMPLES A-F

Ethylene oxide polymerizations are performed using a 48-well Symyx Technologies Parallel Pressure Reactor (PPR). Each of the wells is equipped with an individually weighed glass insert having an internal working liquid volume of approximately 5 mL. 3 mL of a mixture of 98.5% of a 625 weight average molecular weight poly(ethylene oxide) triol and 1.5% glycerol is added to each well, together with 265 parts per million by weight (ppm, based on the expected mass of the product) of a zinc hexacyanocobaltate catalyst complex (Arcol® 3 Catalyst from Covestro), 265 ppm of aluminum oxide (Catalox® BA, from Sasol North America) and 1335 ppm of an additive as indicated in Table 1. The wells are pressurized with 70 psig (483 kPa) dry nitrogen at 160° C. 0.3 mL of ethylene oxide is injected into each well, raising the internal pressure in each well to 140-160 psig (966-1103 kPa). The internal pressure is monitored over time as an indication of the progress of the ethylene oxide polymerization reaction. The times required for the pressure to decline to 90 psig (621 kPa) and then to 80 psig (552 kPa) are recorded. Shorter times are indicative of greater catalytic activity. Results are as indicated in Table 1.

TABLE 1

| | | Time to | Time to |
|---|---|---|---|
| | | 90 psig | 80 psig |
| | | (621 kPa), | (552 kPa), |
| Designation | Additive/ | min. | min. |
| A* | None | >180 | >180 |
| 1 | Na Acetate | 3.5 | 5.7 |
| 2 | K Acetate | 3.8 | 5.9 |
| 3 | Cs Acetate | 5.4 | 9.0 |
| 4 | Na Formate | 8.3 | 14.4 |
| 5 | K Benzoate | 6.8 | 12.25 |
| 6 | Na Laurate | 14.7 | 26.05 |
| 7 | Monobasic | 4.4 | 8 |
| | Potassium | | |
| | Phosphate | | |
| 8 | NH₄H₂PO₄ | 4.9 | 7.3 |
| 9 | LiH₂PO₄ | 8.0 | 12.5 |
| 10 | Na₂HPO₄ | 8.0 | 12.5 |
| 11 | Tartaric acid | 15.9 | 37.5 |
| 12* | Na Stearate | 20.1 | 35.0 |
| B* | Na Triflate | 40.8 | 64.4 |
| C* | K₂HPO₄ | 117. 7 | 136.4 |
| D* | NaHCO₃ | 84.4 | 126.8 |
| E* | Na₂CO₃ | 74.1 | 116.9 |
| F* | Ca Formate | 98.2 | >180 |

*Not an example of the invention.

Comparative Sample A represents a baseline case. The catalyst complex by itself is unable to initiate polymerization under these very stringent conditions (high concentration of hydroxyl groups plus the selection of ethylene oxide). Examples 1-12 show that active polymerization takes place when alkali metal carboxylates (Ex. 1-6 and 12), monobasic potassium phosphate, ammonium dihydrogen phosphate or lithium dihydrogen phosphate (Ex. 7-9), tartaric acid (Ex. 11) or dibasic sodium phosphate (Ex. 12) are additionally present in the reaction mixture. The time for the reactor pressure to decline to 90 psig (621 kPa) is reduced by a factor of 9 or greater in each instance.

Comparative Samples B—F show the poorer effect of various other additives. The triflate salt (Comp. B) provides some benefit, but is much less effective than the additives of the invention. The dibasic potassium phosphate, carbonate salts and the alkaline earth carboxylate salt (Comp. C, D, E and F) provide almost no benefit.

### EXAMPLES 13-23 AND COMPARATIVE SAMPLES G-K

Ethylene oxide polymerizations are performed in the same manner as in the previous set of examples, replacing aluminum oxide with an equivalent concentration of aluminum tri(sec-butoxide). The additive and results are as indicated in Table 2.

TABLE 2

| | | Time to | Time to |
|---|---|---|---|
| | | 90 psig | 80 psig |
| | | (621 kPa), | (552 kPa), |
| Designation | Additive/ | min. | min. |
| A* | None | >180 | >180 |
| 13 | Na Acetate | 4.4 | 6.55 |
| 14 | K Acetate | Not Done | 1.8 |
| 15 | Cs Acetate | 5.0 | 8.1 |
| 16 | Na Formate | 6.15 | 9.6 |
| 17 | K Benzoate | 9.2 | 16.4 |
| 18 | Na Laurate | 14.2 | 26.6 |
| 19 | KH₂PO₄ | 13.0 | 20.1 |
| 20 | NH₄H₂PO₄ | 8.5 | 180 |
| 21 | Na Stearate | 19.8 | 35.0 |
| 22 | Tartaric Acid | 6.3 | 13.3 |
| 23 | Na₂HPO₄ | 4.2 | 8.3 |
| G* | Na Triflate | 46.0 | 78.7 |
| H* | K₂HPO₄ | 106.9 | 134.5 |
| I* | NaHCO₃ | 86.8 | 125.4 |
| J* | Na₂CO₃ | 159.7 | >180 |
| K* | LiH₂PO₄ | 86.6 | >180 |

*Not an example of the invention.

The alkali metal carboxylates (Ex. 13-18 and 21), the monobasic phosphates (Examples 19 and 20), tartaric acid and disodium hydrogen phosphate (Ex. 22, 23) all dramatically increase the polymerization rate. The triflate salts, K₂HPO₄, the carbonate salts and LiH₂PO₄ provide little if any beneficial effect.

1. A method for producing a polyether, the method comprising:
I. forming a reaction mixture comprising a) a hydroxyl-containing starter, b) at least one alkylene oxide, c) a water insoluble polymerization catalyst complex that includes at least one double metal cyanide compound and d) an additive selected from the group consisting of alkali metal, ammonium and quaternary ammonium salts of monocarboxylic acids having up to 24 carbon atoms; monobasic alkali metal phosphates, dibasic sodium phosphate, monobasic ammonium phosphate, monobasic quaternary ammonium phosphates, tartaric acid, malic acid and succinic acid, and
II. polymerizing the alkylene oxide onto the hydroxyl-containing starter in the presence of the water insoluble polymerization catalyst complex and the additive to produce the polyether.

2. The method of claim 1 wherein the double metal cyanide compound is represented by the formula:
M¹_{b}[M²(CN)ᵣ(X¹)ₜ]_{c}[M³(X²)₆]_{d}·nM⁴ₓA¹_{y} (I)
wherein:
M¹ and M⁴ each represent a metal ion independently selected from Zn²⁺, Fe²⁺, Co⁺²⁺, Ni²⁺, Mo⁴⁺, Mo⁶⁺, Al⁺³⁺, V⁴⁺, V⁵⁺, Sr²⁺, W⁴⁺, W⁶⁺, Mn²⁺, Sn²⁺, Sn⁴⁺, Pb²⁺, Cu²⁺, La³⁺, and Cr³⁺;
M² and M³ each represent a metal ion independently selected from Fe³⁺, Fe²⁺, Co³⁺, Co²⁺, Cr²⁺, Cr³⁺, Mn²⁺, Mn³⁺, Ir³⁺, Ni²⁺, Rh³⁺, Ru²⁺, V⁴⁺, V⁵⁺, Ni²⁺, Pd²⁺, and Pt²⁺;
X¹ represents a group other than cyanide that coordinates with the M² ion;
X² represents a group other than cyanide that coordinates with the M³ ion;
A¹ represents a halide, nitrate, sulfate, carbonate, cyanide, oxalate, thiocyanate, isocyanate, perchlorate, isothiocyanate, an alkanesulfonate, an arylenesulfonate, trifluoromethanesulfonate, or a C₁₋₄ carboxylate;
b, c and d are each numbers that reflect an electrostatically neutral complex, provided that b and c each are greater than zero;
x and y are integers that balance the charges in the metal salt M⁴ₓA¹_{y};
r is an integer from 4 to 6;
t is an integer from 0 to 2; and
n is a number from 0 and 20.

3. The process of claim 1 wherein the reaction mixture further comprises, as a separate component from the water insoluble polymerization catalyst complex, e), at least one M⁵ metal or semi-metal compound, in which the M⁵ metal or semi-metal is selected from magnesium or a metal or semi-metal M⁵ that falls within any of Groups 3 through 15, inclusive, of the 2010 IUPAC periodic table of the elements and the M⁵ metal or semi-metal is bonded to at least one alkoxide, aryloxy, carboxylate, acyl, pyrophosphate, phosphate, thiophosphate, dithiophosphate, phosphate ester, thiophosphate ester, amide, oxide, siloxide, hydride, carbamate, halide or hydrocarbon anion.

4. The method of claim 3 wherein component e) is present in an amount that provides 0.0025 to 50 moles of M⁵ metal per combined moles of M² and M³ metal provided by the double metal cyanide catalyst.

5. The method of claim 3 wherein the M⁵ metal or semi-metal is selected from the group consisting of aluminum, gallium and hafnium.

6. The method of claim 1 wherein the additive is present in an amount of 1 to 10 times that of the catalyst complex, by weight.

7. The method of claim 1 wherein the additive is one or more compounds selected from the group consisting of alkali metal carboxylates, NH₄H₂PO₄, monobasic alkali metal phosphates and Na₂HPO₄.

8. The method of claim 1 wherein the alkylene oxide is ethylene oxide.

9. The method of claim 1 which is semi-batch process comprising steps of charging the catalyst complex and starter to a reaction vessel, activating the catalyst complex and thereafter adding at least a portion of the alkylene oxide to the reaction vessel containing the activated catalyst complex and starter under polymerization conditions without removal of product until all of the alkylene oxide has been added, or a continuous process comprising steps of continuously feeding the catalyst complex, starter and alkylene oxide to a reaction vessel under polymerization conditions and continuously removing product from the reaction vessel.

10. The method of claim 1 wherein the reaction mixture has a hydroxyl content of 4.25 to 15 wt. %, based on the total weight of the reaction mixture, during at least a portion of step II.
